(19) United States
(12) Patent Application Publication
(10) Pub. No.: US 2025/0339755 A1
(43) Pub. Date: Nov. 6, 2025

(54) SCORE COUNTING DEVICE

(71) Applicant: Raymond ADAMS, Cumbria (GB)

(72) Inventor: Raymond ADAMS, Cumbria (GB)

(21) Appl. No.: 19/198,016

(22) Filed: May 3, 2025

(30) Foreign Application Priority Data
May 3, 2024 (GB) 2406203.6

(51) Int. Cl. A63B 71/06; A63B 102/32; G04G 9/00

(52) U.S. Cl. CPC A63B 71/0669; G04G 9/007; A63B 2071/0663; A63B 2102/32; A63B 2220/12

(57) ABSTRACT

The present invention relates to a score counting device comprising a strap and a housing, wherein the housing includes a processor, a battery, a display screen, and a plurality of input buttons, wherein a first input button is operative to add a unit to a score displayed on a first page on the display screen, a second input button is operative to subtract a unit from the score displayed on the first page, a third input button is operative to change the first page to a second page, a fourth input button is operative to change the second page to the first page, a fifth input button is operative to activate and deactivate the device and display screen; and a sixth input button is operative to aggregated scores on a third page, and wherein at least one input button is indented in the housing.

### FIELD OF THE INVENTION

The present invention relates to a score counting device, in particular a portable device for keeping score; more particularly but not exclusively a device for keeping score in a game of golf or bowls or similar.

### BACKGROUND

Many people in many societies across the world increasingly enjoy taking part in individual or group sports, such as golf or lawn bowls.

In such sports it is important often for players to make note of their own score, as typically there is no external or dedicated scorer.

This can be problematic to do, as using paper and pens is fiddly, and burdensome when a user has numerous other playing objects and/or is less mobile, as is common in players of such sports.

### PRIOR ART

US 2021 0 113 911 (MADSEN) discloses apparatus worn on the wrist of a tennis or pickleball player for keeping score during tennis or pickleball comprising a small “watch-like” processor/display unit which digitally displays the scores in response to the player depressing appropriate input buttons. said processor/display unit and said wrist sweatband.

EP 1 806 682 (JAERMANN et al) discloses a mechanical counter for use in a timepiece golf, comprising a first counter for counting a number of beats per hole with a display, a second counter with a display of a total number of beats, a third counter with a display of holes played, wherein a pusher means for automatically indexing the third counter resets the first counter to a zero position, characterized in, that the display of the second counter rotatable about a central axis of the golf counter a sum indicator.

JP 7 028 944 (NAKAZAWA et al) discloses operating switches for an electronic wristwatch wherein when a player finishes a hole, the player inputs the number of strokes and the score of the first hole is stored by operating switches and the total number of pars may be calculated, displaying a date and the difference between the scores and pars in a round.

GB2314779A (LEE) discloses a portable game or sport scoring apparatus adapted for being worn with one or more input buttons to incrementally adjust the score of a player and opponent.

GB2468479A (ODUNAIKE) discloses a game scoring device with a main body, display screen and watch-strap powered by a battery. The user presses buttons or pins to apply a method to input and review of data.

GB2566666A (HOUGHTON) discloses an electronic device for keeping scope during a game.

KR102547526B1 (LEESANGSOO) discloses a golf stroke counter.

U.S. Pat. No. 8,040,758B1 (DICKINSON) discloses a wrist worn apparatus for monitoring user's performance while playing golf.

### SUMMARY OF THE INVENTION

According to a first aspect of the invention there is provided a score counting device comprising a strap and a housing, wherein the housing includes a processor, a battery, a display screen, and a plurality of input buttons, wherein a first input button is operative to add a unit to a score displayed on a first page on the display screen, a second input button is operative to subtract a unit from the score displayed on the first page, a third input button is operative to change the first page to a second page, a fourth input button is operative to change the second page to the first page, a fifth input button is operative to activate and deactivate the device and display screen; and a sixth input button is operative to aggregate scores on a third page, and wherein at least one input button is indented in the housing.

The device of the present invention thereby allows a user to easily and conveniently input a score, in real-time whilst playing a game such as golf. Additionally or alternatively, the device enables the user to monitor their progress during the game, for example in both the round and the overall game, in relation to a standard par and/or the hole par.

In preferred embodiments the device is a form of wristwatch with a means of keeping score on a number of holes or rounds in a game, being portable, convenient and robust.

The preferred embodiment provides a wearable device for keen golfers to allow them to easily keep track of their score in a round of golf and displays the shot count for each hole. The score counting device may also track and display whether the player is over or under a standard 72 par.

In this way the user does not have to carry a scorecard or use their mobile phone to input their score data, and the device provides a wearable solution that is more convenient to use and take around the course.

In some embodiments, the score counting device may have more than 6 input buttons. These input buttons can include activating or deactivating the device, adding a unit to a score displayed, subtracting a unit from the score, changing the first page to a second page on the device, changing the second page to the first page and monitoring aggregated scores. It will be appreciated that where the device comprises more input buttons, the device will have greater functionality and sophistication in its utility.

The input buttons are pressed to initiate a command signal that is sent to the processor provided on the device. The input buttons may project from the housing and be depressed towards the housing to initiate a command signal, or the input buttons may be indented within a recess on the housing so that the input button itself does not project from the housing but is arranged in a recess to help avoid erroneous depression of the input button. Advantageously, having different styles or sizes or shapes of input buttons on the same device also allows a user to distinguish between buttons by touch.

The processor is typically a printed circuit board (PCB) with a microprocessor arranged within the housing. The microprocessor receives an input signal (command signal) when an input button is activated. The one or more signal is processed to display an output on the display screen of the device, for example to display a score number.

In some embodiments of the device the input buttons are provided in sets of two arranged in opposing locations on the housing perimeter, providing an intuitive, easy to operate and convenient means of control.

In some such embodiments of the device the first input button and second input button form a set, located central the housing in relation to a strap axis.

In some embodiments of the device the third input button and fourth input button are located towards the bottom of the housing in relation to a strap axis. In this way these input buttons (inputs) may be more convenient and intuitive for access when the device is worn, as standard, on a left wrist.

The third input button is adapted to change the first page to a second page which may correspond to recording a score on one page that corresponds to one hole and moving to a second page that is a second hole. Thereby the act of pressing the third input button both records (saves) the score and moves to the next page.

The fourth input button is adapted to change the second page to the first page, which may correspond to an earlier hole, so that a user can correct their score.

The device comprises a fifth input button which provides a means of activation or deactivation of the device or display screen. The fifth input button is therefore a form of START button.

In some such embodiments of the device the fifth input button may be indented in the housing, such that it is not liable to be accidentally activated, used or depressed.

The device comprises a sixth input button which provides a means of monitoring aggregated scores on a third page.

In some such embodiments of the device the sixth input button may also be indented in the housing, such that it is not liable to be accidentally activated, used or depressed. In other embodiments, any combination of the input buttons can be indented in the housing depending on the user requirements or preferences.

In a preferred embodiment the fifth and sixth input buttons are indented so that these input buttons are distinguished from the other input buttons.

In some embodiments the device comprises a displaceable battery cover so that the battery(s) can be accessed. Preferably, the battery cover is provided with a screw fitting. In this way the device may be maintained by a user solely. The battery cover may preferably comprise a silicone gasket for example, so as to ensure waterproofing and prevent particle ingress.

In some embodiments of the device the device comprises GPS (a global positioning system networking capacity), which may be envisaged to be operable with a map of a course for example, accessed, controlled or monitored from a software interface such as on a smartphone by known means.

In a preferred embodiment, the device comprises GPS and a means to connect to an independent electronic device, such as a computer, to download the pars for the holes, for example through a universal serial bus (USB) connection or through a wireless transceiver, so as to allow for downloading of data regarding the par.

In some embodiments the device includes a receiver, a transmitter, a transceiver and/or a means for receiving a wired connection to an external device. For example, the transceiver can be used for providing wireless, radio wave or intermachine operability such as Bluetooth®. This may enable upload or download of data, maps or scores. The wired connection may be any suitable connection means, such as a link cable, such as a universal serial bus (USB), Mini-USB, USB-C or Micro-USB.

In some embodiments, the device provides a wireless or wired link to independently available electronic apparatus for operation through a downloaded software interface. It may be envisaged that the present invention may comprise such apparatus. Examples of suitable electronic apparatus include mobile phones, tablets and computer devices. The software interface may be downloaded and run by known means to the person skilled in the art.

Preferably, the device can also be configured to transfer user data, such as scores, from the score counting device to an electronic apparatus wirelessly through the transceiver and/or through the wired connection to store user history. The electronic apparatus sends an input signal requesting the user data either wirelessly to the transceiver on the device or sends the input signal through the wired connection to the device. The user can then accept the request by pressing a START button on the device to establish the connection and transfer the data to the electronic apparatus.

In some embodiments the score counting device transfers an input signal through the wireless or wired link to the electronic apparatus to transfer user data to the electronic apparatus. Advantageously, this provides a means for the user to transfer obtained data, such as scores and other variables to the electronic apparatus so the user can maintain a user history to keep track of their scores and other data or compare data against others.

In some embodiments, a combination of input buttons is pressed simultaneously to access additional menu screens. Advantageously, this permits the device to provide additional screens beyond a single button press. These menu screens can include user history or option menus for altering user preferences on the device, such as the screen contrast and sleep mode settings.

In other embodiments, the device is a handheld device. The handheld device can be any suitably designed handheld device, such as the design of a stopwatch or other known handheld modules. These handheld devices can be attached to a strap that can be secured to the user when the device is not in use.

In a further aspect of the invention there is a method of using the score counting device, wherein the method comprises the step of pressing one or more buttons on the device.

In further aspects of the invention there is a method for using the device in a hole of golf, wherein the method comprises the steps of:
pressing the fifth input button to activate the device;
pressing the first or second input button to add or remove numerical values to a score and;
pressing a third input button to record the score.

In a further aspect of the invention there is a method for using the device in a round of golf, wherein the method comprises the steps of:
pressing a fifth input button to activate the device,
pressing the first or second input button to add or remove numerical values to a score,
pressing a third input button to record the score and move to the next hole (page) on the device and;
   repeating the second and third steps until the round of golf is complete.

The method for using the device in a round of golf may also comprise the step of pressing the sixth input button for viewing the score for the round.

The strap may be provided in multiple colours and materials. In a preferred embodiment the strap is formed from silicone and may be provided in a range of different colours or patterns. In a preferred embodiment, the strap is a wrist strap. Preferably, the wrist strap is a silicone buckle strap that is both simple to fasten and comfortable to wear, meaning that the user is more inclined to use the device during play, with golf in particular being a style conscious sport.

A preferred embodiment of the invention will now be described by way of example only and with reference to the Figures in which:

### BRIEF DESCRIPTION OF FIGURES

FIG. 1 shows an isometric view of an embodiment of the device according to the present invention;

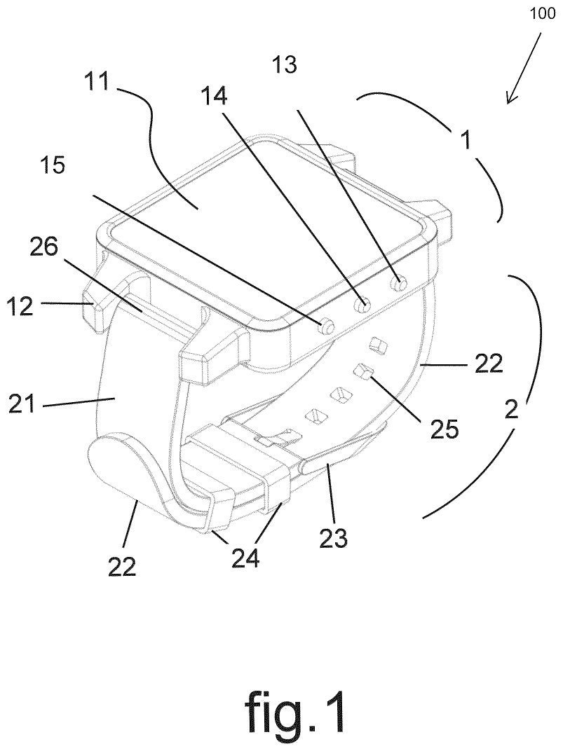

FIG. 2 shows a reverse isometric view of the embodiment of the device shown in FIG. 1;

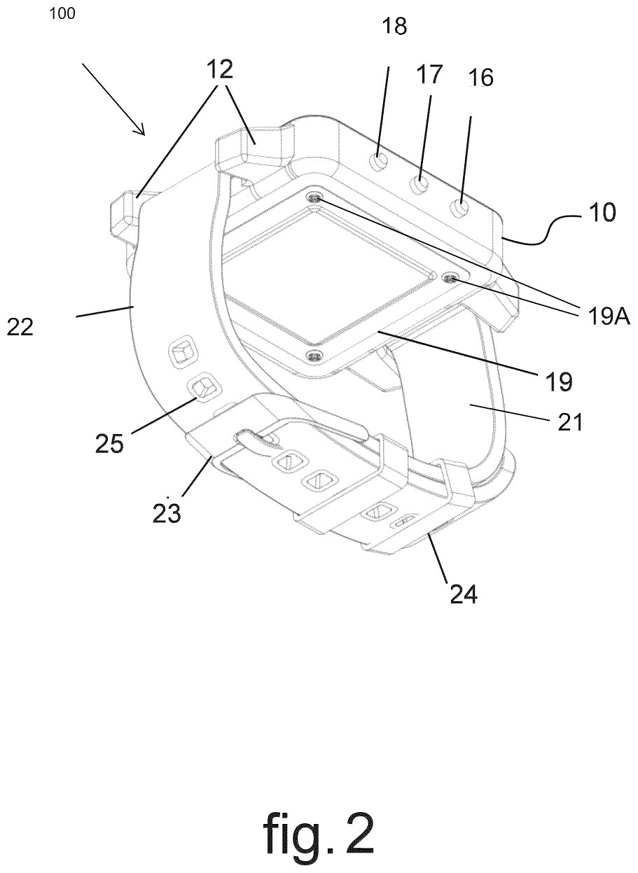

FIG. 3 shows an exploded isometric view of the embodiment of the device shown in FIG. 1;

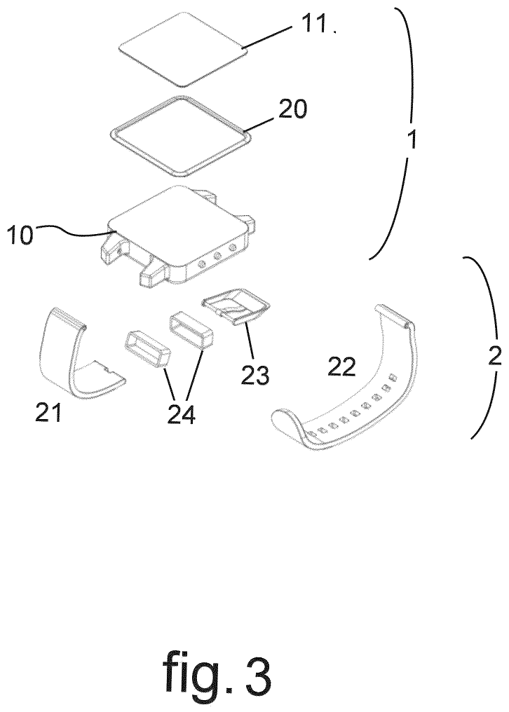

FIG. 4 shows a reverse exploded isometric view of the embodiment of the device shown in FIG. 1;

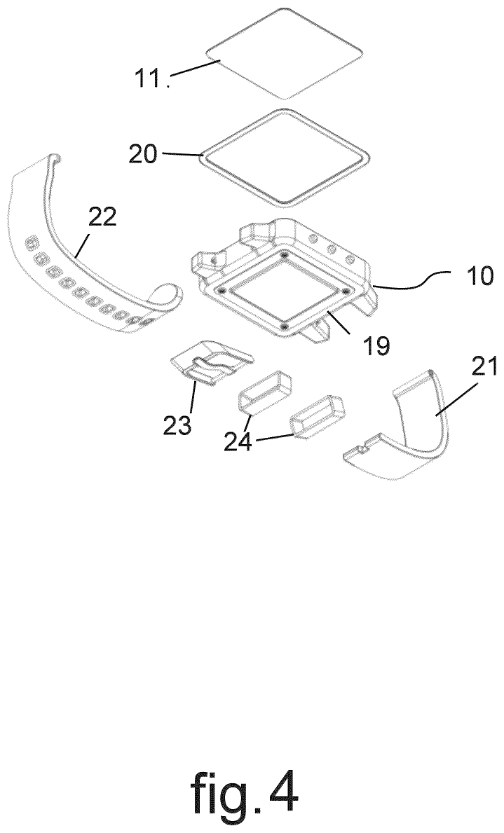

FIG. 5 shows a schematic view of an embodiment of the device according to the present invention, in use; and

FIG. 6 shows a diagrammatic view of the embodiment of the device shown in FIG. 1.

### DETAILED DESCRIPTION OF FIGURES

With reference to the figures there is shown a preferred embodiment of a score counting device 100 comprising a wrist strap 2 and a housing 1, wherein the housing comprises a processor (not shown) and a battery (not shown), a display screen 11, and six input buttons (13, 14, 15, 16, 17, 18).

A first input button 14 is adapted to add a unit to a number displayed on a first page on the display screen, a second input button 17 is adapted to subtract a unit from the number displayed on the first page, a third input button 13 is adapted to change the first page to a second page, and a fourth input button 18 is adapted to change the second page to the first page.

A fifth input button 16 provides a means of activation or deactivation of the device or display screen, a sixth input button 15 provides a means of monitoring aggregated scores on a third page.

The input buttons 13, 14, 15, 16, 17, 18 are operatively connected to the processor (not shown) so that activating an input initiates a command signal (input signal) that is received and processed by the processor to generate an output.

In particular reference to the pictured preferred embodiment, the score counting device 100 is a wristwatch, with a wrist strap 2 having a buckle closure means 23, 25, and securing bands 24.

The housing 1 has a flat display screen 11, which preferably comprises a low power e-ink style or monochrome liquid crystal display (LCD) screen as known in the art. It is appreciated that other types of display may be used, for example colour displays such as an Active Matrix Organic Light-Emitting Diode (AMOLED) display.

The housing 1 comprises a substantially rectangular face providing the display screen 11 and has physical button controls 13-18 (input buttons) arranged to either side of the housing 11.

The housing 1 is comprised by a metal or plastic tray 10 having two sets of shoulders 12 for receipt of pins 26 supporting the laterally perforated ends of the strap parts 22, 21.

The strap parts comprise a first part 22 having longitudinally spaced buckle holes 25 as known in the art, and a distal strap part 21 providing an endmost metal buckle 23. This strap part 21 also includes loops 24 for the first strap part 22.

The physical input buttons 13, 14, 15, 16, 17, 18 are arranged in sets of two (set one 13, 14, 15 and set two 16, 17, 18) in corresponding locations on opposing locations on the housing 1.

A first set of input buttons 14, 17 provides a plus or minus first input. One of the first input buttons is adapted to add a unit to a scoring number displayed on a first page on the display screen, which may be envisaged to related to the first hole in a game of golf.

The other first input button is adapted to subtract a unit from the scoring number displayed on this first page.

For example, first input button 14 of the first set may be used to add a unit to the score and second input button 17 of the first set may be used to subtract a unit from the score.

The first set of input buttons 14, 17 is located longitudinally central the housing 1, in relation to the strap's axis. In this way the buttons are easy to operate and are predominant on the housing. It may be envisaged that in some further embodiments the first set of buttons may be coloured differently and/or of a larger size, for example extending further from the housing, such that such first set of buttons may be more usable or dominant, so as to indicate or encourage more frequent usage.

A second set of two input buttons 13,18 is located at a lower edge of the housing tray 10 in relation to the strap axis, for example so as to be closer to the user's body when the device is worn.

The second set of input buttons 13, 18 comprises the third 13 and fourth 18 input buttons, and these relate to changing the pages on the display 11, which may be envisaged to relate to a page per hole. The second set of input buttons 13, 18 may in some embodiments be less prominent, for example being smaller, rather than all the input buttons being the same size as shown in the drawings.

The third input button 13 is adapted to change the first page to a second page, and the fourth input button 18 is adapted to change the second page to the first page.

The preferred embodiment further comprises a third set of input buttons 15, 16, which are located at the top end of the housing 1 and comprise a fifth input button 16 which provides an activation control for the device or display screen, and a sixth input button 15 which provides access to a third page, which third page provides a display showing an aggregation of the scores, providing information regarding the round of golf, in relation to pars for the round or the holes.

To return from the third page the sixth input button 15 is pressed again.

Not shown in the figures, in the preferred embodiment at least one of the input buttons are indented in the housing 1. In other embodiments, either the fifth or the sixth input buttons 16, 15 is indented in the housing. In other embodiments, other combinations of the input buttons can be indented in the housing depending on user requirements.

In the preferred embodiment, a combination of buttons, such as the third and fourth input buttons 13, 18, is pressed simultaneously to access additional menu screens. In this example, pressing the third and fourth 13, 18 input buttons together brings forward an options menu that allows the user to modify user preferences on the device. This includes variables such as the screen contrast and sleep mode settings.

The watch face display 11 is rectangular. Preferably the display 11 features a large monochrome LCD screen, allowing the user to easily read all the displayed information.

The housing 1 has a displaceable battery cover 19. The battery cover 19 is on the back of the device so that is it adjacent to a wearer's skin in use. The battery cover 19 can be unscrewed by removing the four screws 19A, allowing the user to remove and replace the battery (not shown).

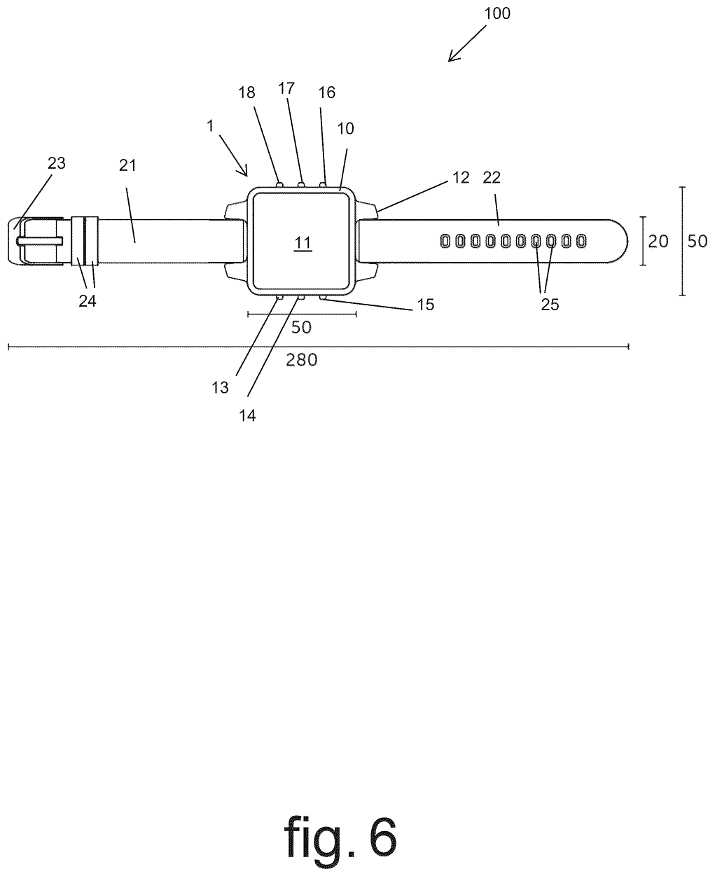

FIG. 6 shows a plan view of the device 100 with some preferred dimensions included. The housing 1 has a length of 50 mm and a width of 50 mm to provide a square display 11. The total length of the device 100 is 280 mm. The strap 21, 22 width is 20 mm. It is appreciated that the housing 1 and strap 21, 22 may be provided in different dimensions.

The preferred embodiment thereby comprises:
START Input button (fifth input button) 16: Turns the device on and off.
ROUND Input button (sixth input button) 15: Displays the shots for the whole round, to return to the previous screen if pressed again.
− Input button (second input button) 17: Subtracts 1 shot from the current hole.
+ Input button (first input button) 14: Adds 1 shot to the current hole.
BACK Input button (fourth input button) 18: Moves the screen back to the previous page that may correspond to the previous hole.
NEXT Input button (third input button) 13: Moves the screen to the next page that may correspond to the next hole.
Silicone strap buckle watch strap 21, 22, 23, 24.
Bezel Ring 20
Display 11 with a Crystal Cover to protect the LCD screen.
M2 Screws 19A to allow the user to remove a rear battery cover 19.
User replaceable 3V Button Battery (not shown)
Printed Circuit Board (PCB that is not shown).

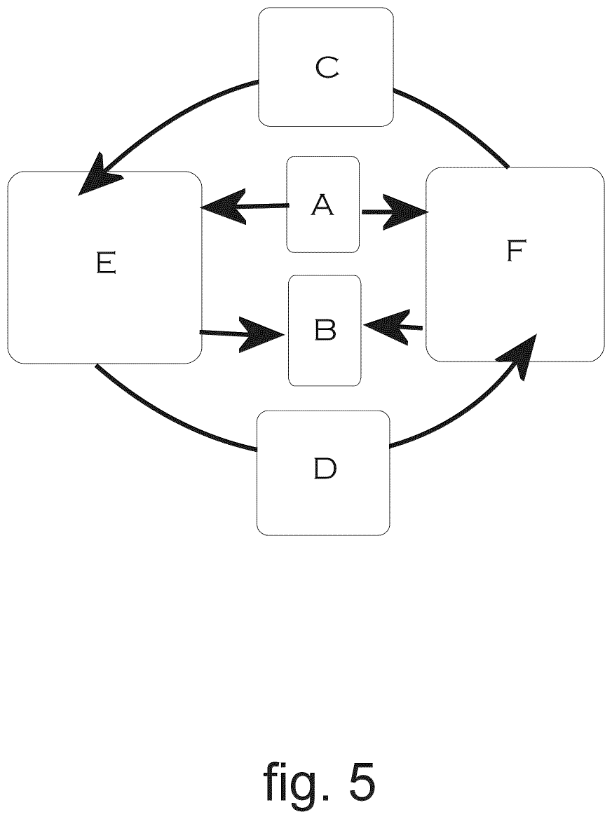

With reference to FIG. 5, in use, the device as shown in diagrammatic form, the input buttons A and B (provided in the pictured embodiment by input buttons 14,17) add or subtract score units from the screens E and F, and inputs C and D (provided in the pictured embodiment by input buttons 13,18) change between screens shown on the display 11.

In an example, the user straps on the device 100 before starting a round of golf, or other activity that requires a score to be kept in a similar manner. When they are ready to play, they press the START input button 16. In a preferred embodiment the START input button 16 may be green to provide an easy to recognise visual indicator.

After a shot, the user can press the first input button 14 (+ button), if they mistakenly add too many units, they can use the second input button 17 (− button) to subtract a shot added in error.

In the case of playing a round of golf this method of recording the score repeats until the user putts the ball into the hole. Once the hole is complete, the user then presses the NEXT input button 13 to record the score and go on to the next hole. If the user needs to alter the score for the previous hole, they can hit BACK input button 18 and alter the shot count.

During any point in the game, the golfer can hit the ROUND input button 15 to see their score for the whole round, pressing it again to return to the previous screen. The user can also view if they are over or under par.

Through pressing the appropriate input buttons, the user can view and analyse their round. If the user wishes to finish, then they can simply press the START input button 16 to turn off the device.

It is appreciated that the input buttons each perform a dedicated function and that the function of each input button may be different on different models of the device, or it may be possible to program the processor so that the function of each input button can be altered for user preference.

The invention has been described by way of examples only and it will be appreciated that variation may be made to the above-mentioned embodiments without departing from the scope of protection as defined by the claims.

1. A score counting device comprising a strap and a housing, wherein the housing includes a processor, a battery, a display screen, and a plurality of input buttons, wherein a first input button is operative to add a unit to a score displayed on a first page on the display screen, a second input button is operative to subtract a unit from the score displayed on the first page, a third input button is operative to change the first page to a second page, a fourth input button is operative to change the second page to the first page, a fifth input button is operative to activate and deactivate the device and display screen; and a sixth input button is operative to aggregate scores on a third page, and wherein at least one input button is indented in the housing.

2. A score counting device according to claim 1 wherein the fifth and sixth input buttons are indented.

3. A score counting device according to claim 1, wherein the input buttons are provided in sets on two arranged in opposing locations on the housing perimeter.

4. A score counting device according to claim 1, wherein the first input button and the second input button form a set, located central the housing in relation to a strap axis.

5. A score counting device according to claim 1, wherein the third input button and the fourth input button are located towards the bottom of the housing in relation to a strap axis.

6. A score counting device to claim 1, wherein the third input button provides a means of moving to the second page that corresponds to the next hole page.

7. A score counting device to claim 1, wherein the fourth input button provides a means of returning to the first page to allow a user to correct the score for a previous hole.

8. A score counting device according to claim 1, comprising a battery cover which is provided with a screw fitting.

9. A score counting device according to claim 1, comprising GPS.

10. A score counting device according to claim 1, comprising a transceiver and/or a means for receiving a wired connection to an external device.

11. A score counting device according to claim 10, providing a wireless or wired link, wherein the external device is an independently available electronic apparatus for operation through a downloaded software interface.

12. A score counting device according to claim 11, wherein the score counting device transfers an input signal through the wireless or wired link to the electronic apparatus to transfer user data to the electronic apparatus.

13. A score counting device according to claim 1, wherein a combination of buttons is pressed simultaneously to access additional menu screens.

14. A score counting device according to claim 1, wherein the score counting device is a handheld device.

15. A method of using the score counting device according to claim 1 comprising the step of pressing one or more buttons on the device.

16. A method for using the device according to claim 1 in a hole of golf, wherein the method comprises the steps of:
pressing the fifth input button to activate the device,
pressing the first or second input buttons to add or remove numerical values to a score and;
pressing the third input button to record the score.

17. A method for using the device according to claim 1 in a round of golf, wherein the method comprises the steps of:
pressing the fifth input button to activate the device,
pressing the first or second input button to add or remove numerical values to a score,
pressing the third input button to record the score and move to the next hole on the device and;
repeating the second and third steps until the round of golf is complete.

18. The method according to claim 17 comprising the additional step of pressing the sixth input button for viewing the score for the round.
